(19) United States
(12) Patent Application Publication
(10) Pub. No.: US 2009/0141704 A1
(43) Pub. Date: Jun. 4, 2009

(54) Hybrid Protocol Voice Over the Internet Calling

(75) Inventors: Kai Y. Eng, Atlantic Highlands, NJ (US); Pramod Pancha, Somerset, NJ (US); Siu Yu Yuen, Kowloon (HK)

Correspondence Address: GIBSON & DERNIER L.L.P., 900 ROUTE 9 NORTH, SUITE 504, WOODBRIDGE, NJ, 07095, US

(73) Assignee: BORO NETWORKS INC., Atlantic Highlands, NJ (US)

(21) Appl. No.: 11/949,161

(22) Filed: Dec. 3, 2007

(51) Int. Cl. H04L 12/66

(52) U.S. Cl. 370/352

(57) ABSTRACT

A click to talk system for use in a data network is disclosed. In response to a user selection on a browser, a click to talk server bridges an IP capable voice device to the browser by translating between data network protocols. Additionally, a media server may be manually or automatically contacted to provide a media stream simultaneously with a voice connection between a client computer running the browser and the IP capable voice device.

### TECHNICAL FIELD

This invention relates to Internet telephony, and more specifically, to an improved technique of implementing telephone calls over the Internet. The technology is also applicable to downloading additional media to a client computer while the computer is engaged in a Voice over the Internet (VOIP) telephone calls with an Internet protocol private branch exchange (IP-PBX).

### BACKGROUND OF THE INVENTION

With the growth of the Internet in the mid-1990s, it became somewhat commonplace to utilize the Internet for completing telephone calls over long distances. These voice-over-the-Internet (VOIP) systems typically operate using a set of gateways for placing calls onto the Internet and taking them off of the Internet. FIG. 1 shows a typical such prior art system including exemplary gateways 102-104 connected to a depiction of the Internet 101. The gateways connect public switched telephone networks (“PSTN”) 105 and 106 through the Internet. It is understood that PSTNs 105 and 106 may actually be different portions of the same PSTN, as the PSTN is capable of connecting callers worldwide. Exemplary telephone devices 107 and 108 are also shown.

When telephone 107 desires to place a call to telephone 108, telephone 107 simply dials the number of telephone 108 as usual. PSTN 105 includes a series of switches that decode the called telephone number and direct the call to Internet gateway 102. Internet gateway 102 forms a virtual connection to Internet gateway 104 in accordance with known Internet protocols for call setup. Such protocols operate to provide, to Internet gateway 102, the IP address of Internet gateway 104 so that a connection can be established. Numerous such protocols are known in the art.

Once Internet gateway 104 receives the call, a PSTN connection over PSTN 106 is set up to call telephone 108. Thus, the completed call includes essentially three “legs”. The first leg is completed over PSTN 105, the second leg is completed over the Internet, and the third leg is completed over PSTN 106. By setting up the system so that the bulk of the call's distance is between gateways 102 and 104, long distance charges are avoided. For example, gateway 102 may be in New York and gateway 104 in Tokyo, Japan. The PSTNs 105 and 106 are typically used only for short distances across local telephone exchange.

The prior art also includes examples of calling devices such as IP phones, which operate using Internet protocol

One problem with such prior art systems is that the local PSTN telephone calls, while less expensive than the long distance call, still incurs a charge. Additionally, with more and more businesses and consumers having local VOIP capability directly on premises, the incoming PSTN call may actually be terminated at a VOIP capable device. Accordingly, the prior art systems are somewhat suboptimal in taking advantage of the benefits of the Internet for conveying voice calls.

### BRIEF DESCRIPTION OF THE DRAWINGS

FIG. 1 depicts a conceptual diagram of a prior art voice-over-the-Internet protocol (VOIP) telephone calling system;

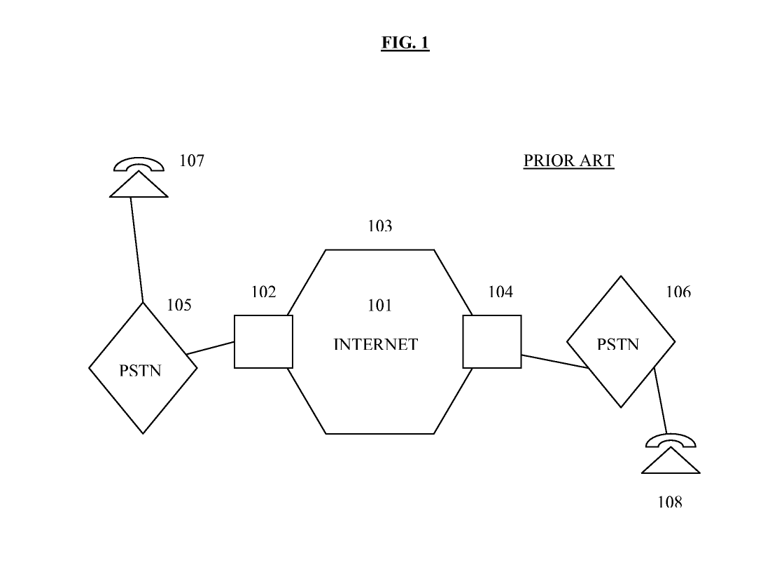

FIG. 2 depicts a conceptual architecture of one portion of an exemplary embodiment of the present invention;

FIG. 3 shows a block diagram of a click-to-talk (CT) server in accordance with the present invention; and

FIG. 4 shows a conceptual diagram of a portion of the Internet 101 with several exemplary computers for purposes of explaining the operation of the invented methodology.

### DETAILED DESCRIPTION OF THE PREFERRED EMBODIMENTS

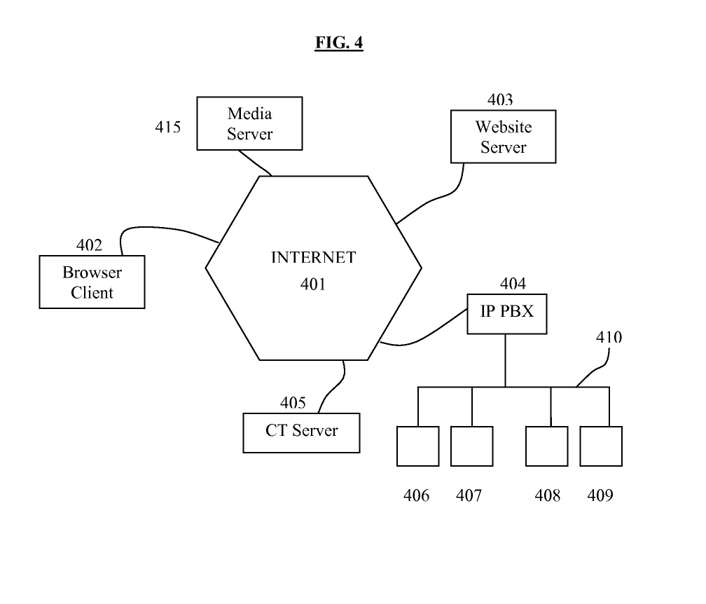

FIG. 4 depicts several exemplary computers connected to an Internet portion 401. The computers include a client computer 402 with a browser, a website server 403, an IP private branch exchange (IP PBX) 404, and a Click To Talk (“CT”) server 405. The website server 403 is typical of modern day websites and may display graphics, forms to be completed, or other items depending upon the particular business application. Often, the known Hypertext Markup Language (“HTML”) is used for such purposes. The communications between the client computer 402 and the website server 403 often takes place using a protocol known as HTTP.

The IP PBX 404 is also commercially available and is the digital, modern day equivalent of an analog PBX. The IP PBX 404 accepts VOIP calls from Internet 401 and can distribute those calls to VOIP devices 406-409 over company data network 410. The devices 106-109 may be IP phones, computers with voice capability, or similar devices.

A CT server 405 is attached to the network and includes different types of communication ports, to be discussed later herein. The CT server 405 is also capable of communicating with the client browser 402, the website server 403, and the IP PBX 404. A media server 415 is also depicted, which media server 415 may interact with the IP PBX 404, one of devices 406-409, and possibly the CT server 405 as explained below.

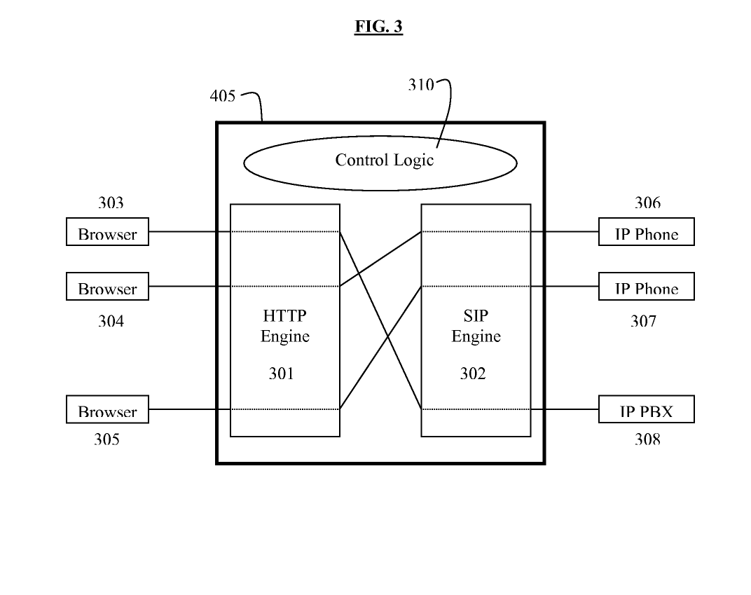

Turning to FIG. 3, shown therein as a slightly more detailed diagram of a CT server 405. The CT server 105, conceptually, functions like a modified telephony switch that operates over the Internet or other data network using two different data network protocols. In the example shown in FIG. 3, the two protocols are Hypertext transmission protocol (“HTTP”) and session initiation protocol (“SIP”) as indicated by the HTTP and SIP engines 301 and 302, respectively. Each of the engines is connected to several devices as shown, the HTTP engine 301 interfacing with HTTP browsers 303-305, typically running on client computers, while the SIP engine interfaces with VOIP capable devices 306-308.

As is known in the art, SIP is a protocol used for implementing voice calls over a data network, setting up and tearing down the calls, etc. It is noted that the protocols depicted in FIG. 3 are for exemplary purposes, and are not critical to the present invention. SIP can be replaced with H323 for example, and other communications protocols may be used as well on either set of switch ports. Additionally, it is contemplated that each set of ports may support multiple protocols. For example, the “browser side” of the switch may include HTTP, and other TCP or UDP-based protocols and the IP Phone side of the CT-server shown in FIG. 3 may include engines to support SIP, H323 or MGCP protocols. As the control logic 310 acts logically like a switch, the control logic 310 can connect various browser side protocols to various IP Phone side protocols as required.

Returning to FIG. 4, and for purposes of explanation, consider the browser client 402 “surfing” the web and viewing the website hosted by website server 403 in accordance with conventional techniques. The viewed webpage may have a CT link, the link upon which the user can click in order to be connected with a voice connection to, for example, a telephone agent. Upon clicking that CT link, the browser client is transferred to CT server 405, and a message is sent to the CT server 405 to initiate a voice connection. Upon such user selection, the browser client 402 also conveys a message to CT server 405 which indicates the IP address of the browser client 402.

The client computer, upon selection of the CT-link by the user, may also transmit a telephone number or IP address associated with IP-PBX 404, or with an individual one of devices 406-409. If the format or address of the information necessary to reach the called device (e.g.; 407) needs translation, CT-server 405 may be programmed to accomplish that task, for example, by translating a telephone number to an IP address, or translating one address to another, or extracting portions of the transmitted data that are known to represent an address.

CT server 405 then initiates a SIP connection to an IP PBX 404 or other VOIP capable device over the Internet 401. The SIP protocol is implemented between CT server 405 and IP PBX 404 in order to arrange for a VOIP connection between the two. The IP PBX 404 then completes the call to the appropriate called device 406-409, using techniques well known in the art for completing such VOIP calls. The SIP or other protocol used between CT-Server 405 and the voice device 406-409 is more optimized for audio communications than is the HTTP or other protocol used between the client 402 and the CT-server 405. Regardless of the particular protocols used, the invention preferable operates such that the connection between CT-server 405, and the one or more voice devices 406-409 is more optimized for voice than the connection between ct-server 405 and the client computer 402.

The last substantive task of the CT server 405 is then to bridge the SIP connection to the HTTP connection, so that the browser to CT server connection will be bridged to the CT server to IP PBX connection, and a completed call path will exist between client 402 and one or more IP devices 406-409. This is accomplished by the control logic 310 shown in FIG. 3. Such logic keeps track of which of the browsers 303-305 should be bridged to which of the IP devices 306-308. Additionally, the media contained within HTTP and SIP package is translated, each to the other, to facilitate the connection. Then a user of the browser client 402 can speak directly to an agent seated at VOIP device 107, for example.

During such conversation, the user of such VOIP device 407 for example, may desire to download additional media to the browser client 402. This could be the case for example, if it were desirable to have a media stream sent to the browser client during the conversation. Taking VOIP device 407 as an example, a user selects media to be downloaded via a conventional menu system, by entering it on a keyboard, touch select, or any other desired methodology.

Upon receipt of such command, a control signal is sent over Internet 401 from device 407 to media server 1 15. Media server 415 is shown separate in FIG. 4, but it is contemplated that it may be integrated with the IP-PBX, one or more of the devices 406-409, the CT server 105, or any combination of computers at all.

The media server receives the control signal and retrieves certain desired media, such as a video or graphics file. The particular desired media may be retrieved by specifying it in the control signal, or by having the media server base such decision upon a prescribed relationship between the requesting device, the browser, etc., and the particular media. It may also be session specific, dependant upon the specific users, or the specific time, or any other parameter specific to the session. Once the media is retrieved, it may be transmitted to the client 402 using HTTP or other protocol, and either through the CT server 405, or directly to client 402, or via another intermediate computer. Preferably, such media transmission is simultaneous with an audio conversation between a user of device 407, for example, and a user of browser 402. Preferably, the media server may transmit graphics, video, or other media forms.

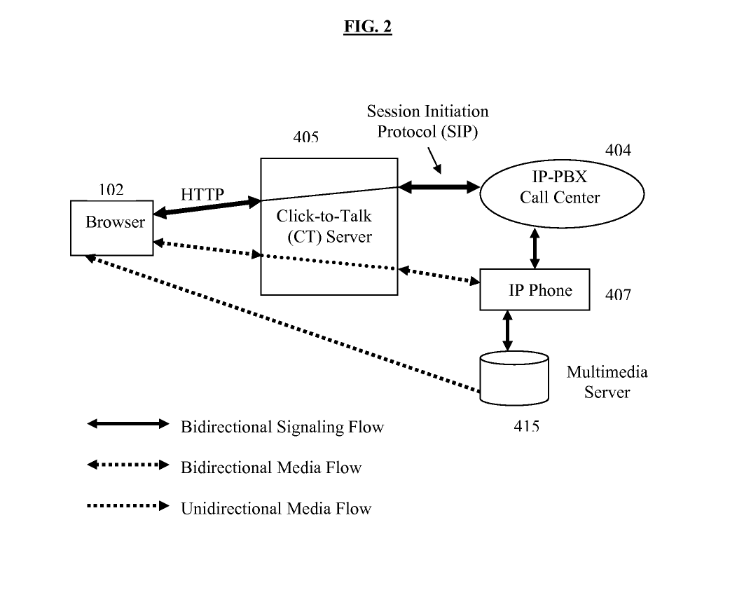

The browser is specially programmed to differentiate between HTTP data packets arriving from media server 415, and HTTP packets arriving from device 407. For the latter, such HTTP packets are treated as audio. A conceptual diagram of how the media server 415 would communicate with the client computer 402 while the client computer 402 also communicates with an exemplary IP device 407 is shown in FIG. 2. It is noted that the indications of bidirectional and unidirectional communications are the preferred embodiments only, and that any of the communications may be unidirectional or bidirectional. Additionally, the direct communications between media server 415 and client computer 402 is also be way of example only, and such communications may take place through an additional computer, or via one of the

While the above describes the preferred embodiment of the present invention, various modifications and additions will be apparent to those of skill in the art. The protocols may be different, and the computers may be configured to share the functions described herein in a manner than allocates them differently among such computers. It is also possible that the browser display various click to talk links, each of which may invoke different variations of the invention and different embodiments from those described above. Therefore, the following claims are not intended to be limited to the exemplary embodiments described herein.

1. A system comprising a first computer connected via a data network to a website computer, said first computer having transmission means for transmitting a first control signal in response to a user input, said website computer communicating with said first computer to form a graphical display on the first computer:
a CT server, for receiving said first control signal and for establishing an end to end voice connection over said data network between said first computer and a voice capable IP device; and
a media device operatively coupled to the voice capable IP device, said voice capable IP device being capable of instructing said media device, in response to the said CT server establishing an end to end voice connection over said data network, to transmit audio, video, or graphics information to said first computer simultaneously with said voice connection existing.

2. The system of claim 1 wherein said CT server is configured to establish said end to end voice connection by bridging first and second voice connections, said first voice connection being between said first computer and said CT server, and utilizing a first data network communications protocol, and said second voice connection being between said CT server and said voice capable IP device and utilizing a second data network communications protocol, said first and second communications data network protocols being different from each other.

3. The system of claim 2 wherein said first data network communications protocol is HTTP and wherein said second data network communications protocol is SIP.

4. The system of claim 2 wherein said voice capable IP device includes an IP telephone, and wherein said voice capable IP device automatically, substantially upon establishment of said end to end voice connection, issues an instruction to said media device to transmit media to said first computer, wherein the CT server, upon receiving said first control signal, forwards session specific parameters to said voice capable IP device, and wherein said media transmitted to said first computer is either based upon, or determined by, said session specific parameters.

5. The system of claim 4 wherein said voice capable IP device includes a telephone and a personal computer.

6. A method for use over the Internet, the method comprising forming a first connection over said Internet between a user computer having a browser, and a second computer using a first data network protocol, accepting a selection from a user, upon said selection forming a second connection between said user computer and a third computer, wherein said first connection is implemented using a first data network communications protocol, and wherein said second connection is implemented using two legs, one of which uses said first data network protocol, and a second of which uses a second data network protocol.

7. The method of claim 6 wherein the two legs include a first leg from said user computer to a CT server, and a second leg from said CT server to said second computer.

8. The method of claim 6 wherein said second data network communications protocol is relatively optimized for audio as compared to said first data network protocol.

9. The method of claim 8 wherein said first data network communications protocol is HTTP and wherein said second data network communications protocol is SIP.

10. The method of claim 9 wherein, in addition to said second connection between said user computer and said third computer, and voice connection is also maintained between said user computer and an IP PBX.

11. A method of completing a media connection over a data network comprising forming a first connection in a first protocol, transmitting, using a first protocol, display information to a first computer from a second computer to form a display on said first computer, said display having an embedded selection link, in response to activation of said selection link, forming a second connection between said first computer and a third computer, wherein said second connection is comprised partially of a connection using said first protocol, and partially of a connection using a second protocol, said second protocol being dependant upon the particular selection link selected.

12. The method of claim 11 wherein said the first protocol is HTTP and wherein the second protocol is SIP.

13. The method of claim 12 further comprising the step of sending a control signal from said third computer to a fourth computer to cause said fourth computer to download a stream of media to said first computer.

14. The method of claim 13 wherein said media is downloaded simultaneously with a voice connection between said first computer and said third computer.

15. The method of claim 14 wherein said second connection is comprised of a CT server that bridges a first part of said second connection with a second part of said connection, and wherein said media is transmitted directly from said fourth computer to said first computer without being transmitted through said CT server.

16. A server for connection to a packet data network, said server comprising a first plurality of ports for communicating with client computers using a first data network protocol, and a second plurality of ports for communicating with VOIP devices using a second data network protocol, the first and second data network protocols being different from each other, the second data network protocol being relatively optimized for audio communication when compared with the first data network protocol.

17. The server of claim 16 further including software for selectively switching connections between the first plurality of ports and the second plurality of ports.

18. A client computer for communicating over a data network, said client computer having a browser using a HTTP protocol to communicate images with other computers on the data network, said client computer also using HTTP to communicate audio with other computers on the data network, which other computers use SIP to communicate audio.

19. The client computer of claim 18 having means for invoking a translating CT server to translate between SIP and HTTP when a user of said client computer indicates a voice connection is desired.

20. The client computer of claim 18 wherein said browser is configured to simultaneously support at least two HTTP connections, a first one of which is to a second computer communicating in HTTP, and a second one of which is to a third computer communicating using SIP.

21. A browser for use in an Internet client, said browser being programmed to receive plural packets of data, determine whether each of said packets is from a VOIP call or from a website for display, and in response thereto, play as audio the packets from the VOIP call, wherein the packets from the VOIP call and the packets form the website for display both arrive in the same data network communications protocol.

22. The browser of claim 21 wherein said communications protocol is HTTP.

23. The browser of claim 22 wherein said browser is actually running on said Internet client and wherein some of said packets in said HTTP protocol are transmitted to said Internet client originally in HTTP, and wherein some of said packets in said HTTP protocol are audio packets transmitted in SIP and converted by a server on the Internet to HTTP packets.

24. A method of implementing audio and other media communications between users of a data network, said method comprising:
forming a first connection over said data network between a first computer and a second computer, said first connection using a first data network protocol;
upon a prescribed user selection, terminating the connection between the first computer and the second computer, and forming a second connection between the first computer and a CT-server;
transmitting from the first computer to the CT-server, a number indicative of an address at which a third computer can be contacted, said third computer including an audio capable device;
forming a third connection from said CT-server to the third computer over the data network using a second data network protocol, and said number indicative;
bridging second and third connections to form a bridged connection between said first computer and said third computer through said CT-server, said bridging including implementing a translator to translate between the first and second data network protocols; and
in response to a command from said third computer, causing a media connection from a fourth computer to the first computer, and downloading media to said first computer simultaneously with communications taking place over said bridged connection, and also utilizing said first data network protocol.

25. The method of claim 24 wherein said command from said third computer is routed through said CT-server.

26. The method of claim 24 wherein said command from said third computer is not routed through said CT-server.
